(19) United States
(12) Patent Application Publication
(10) Pub. No.: US 2023/0029742 A1
(43) Pub. Date: Feb. 2, 2023

(54) GRADATED INTEGRATED CERAMIC SEPARATOR

(71) Applicant: EnPower, Inc., Indianapolis, IN (US)

(72) Inventors: Raymundo ROIG, Phoenix, AZ (US); Adrian YAO, Palo Alto, CA (US)

(21) Appl. No.: 17/815,462

(22) Filed: Jul. 27, 2022

Related U.S. Application Data
(60) Provisional application No. 63/226,650, filed on Jul. 28, 2021.

(51) Int. Cl. H01M 50/434; H01M 50/403; H01M 50/449

(52) U.S. Cl. CPC H01M 50/434; H01M 50/403; H01M 50/449

(57) ABSTRACT

An electrode including a gradated integrated separator according to the present teachings includes a first layer comprising a first plurality of active material particles adhered together by a first binder, a second layer comprising a second plurality of active material particles mixed with a first plurality of inorganic separator particles and adhered together by a second binder, and a third layer comprising a second plurality of inorganic separator particles adhered together by a third binder. In some examples, the first and second layers are electrically conductive and the third layer is electrically non-conductive.

### CROSS-REFERENCES

The following applications and materials are incorporated herein, in their entireties, for all purposes: U.S. Provisional Patent Application Ser. No. 63/226,650, filed Jul. 28, 2021.

### FIELD

This disclosure relates to systems and methods for electrochemical cells. More specifically, the disclosed embodiments relate to separators for electrochemical cells.

### Introduction

Environmentally friendly sources of energy have become increasingly critical, as fossil fuel-dependence becomes less desirable. Most non-fossil fuel energy sources, such as solar power, wind, and the like, require some sort of energy storage component to maximize usefulness. Accordingly, battery technology has become an important aspect of the future of energy production and distribution. Most pertinent to the present disclosure, the demand for secondary (i.e., rechargeable) batteries has increased. Various combinations of electrode materials and electrolytes are used in these types of batteries, such as lead acid, nickel cadmium (NiCad), nickel metal hydride (NiMH), lithium ion (Li-ion), and lithium ion polymer (Li-ion polymer).

### SUMMARY

The present disclosure provides systems, apparatuses, and methods relating to electrodes and electrochemical cells having gradated integrated separators.

In some examples, an electrode includes: a first layer layered onto and directly contacting a current collector substrate, the first layer comprising a first plurality of active material particles adhered together by a first binder; a second layer layered onto and directly contacting the first layer, the second layer comprising a second plurality of active material particles mixed with a first plurality of electrically non-conductive inorganic separator particles and adhered together by a second binder; and a third layer layered onto and directly contacting the second layer, the third layer comprising a second plurality of electrically non-conductive inorganic separator particles adhered together by a third binder.

In some examples, an electrode includes: an active material layer layered onto and directly contacting a current collector substrate, the active material layer comprising a first plurality of active material particles adhered together by a first binder, wherein the active material layer is electrochemically active and electrically conductive; a hybrid layer layered onto and directly contacting the active material layer, the hybrid layer comprising a second plurality of active material particles mixed with a first plurality of non-active ceramic particles and adhered together by a second binder, wherein the hybrid layer is electrochemically active and electrically conductive; and a separator layer layered onto and directly contacting the hybrid layer, the separator layer comprising a second plurality of non-active ceramic particles adhered together by a third binder, wherein the separator layer is electrochemically inactive and electrically non-conductive; and wherein the first plurality of non-active ceramic particles and the second plurality of non-active ceramic particles collectively provide ion conduction channels through the electrode.

In some examples, a method of manufacturing an electrode having a gradated separator includes: coating an active material layer onto a current collector, the active material layer comprising a first plurality of active material particles; coating a hybrid layer onto the active material layer, the hybrid layer comprising a second plurality of active material particles mixed with a first plurality of inorganic separator particles; and coating a separator layer onto the hybrid layer, the separator layer comprising a second plurality of inorganic separator particles; wherein the first plurality of inorganic separator particles are configured to provide ion conduction channels from the separator layer to the active material layer.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic sectional view of an illustrative electrochemical cell in accordance with aspects of the present disclosure.

FIG. 2 is a schematic sectional view of an illustrative electrode including a gradated separator, suitable for inclusion in the illustrative electrochemical cell of FIG. 1.

FIG. 3 is a sectional view of an illustrative interlocking region included within the illustrative electrode of FIG. 2.

FIG. 4 is a schematic sectional view of an illustrative electrochemical cell including a gradated separator in accordance with aspects of the present disclosure.

FIG. 5 is a flow chart depicting steps of an illustrative method for manufacturing electrodes in accordance with aspects of the present disclosure.

FIG. 6 is a schematic sectional view of an illustrative electrode undergoing a calendering process in accordance with aspects of the present disclosure.

FIG. 7 is a schematic diagram of an illustrative manufacturing system including a slot die head having two die slots, suitable for manufacturing electrodes and electrochemical cells of the present disclosure.

FIG. 8 is a schematic diagram of an illustrative manufacturing system including a slot die head having three die slots, suitable for manufacturing electrodes and electrochemical cells of the present disclosure.

### DETAILED DESCRIPTION

Various aspects and examples of electrodes and electrochemical cells having gradated ceramic separators, as well as related methods, are described below and illustrated in the associated drawings. Unless otherwise specified, an electrode or electrochemical cell in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Elongate” or “elongated” refers to an object or aperture that has a length greater than its own width, although the width need not be uniform. For example, an elongate slot may be elliptical or stadium-shaped, and an elongate candlestick may have a height greater than its tapering diameter. As a negative example, a circular aperture would not be considered an elongate aperture.

“Coupled” means connected, either permanently or releasably, whether directly or indirectly through intervening components.

“Resilient” describes a material or structure configured to respond to normal operating loads (e.g., when compressed) by deforming elastically and returning to an original shape or position when unloaded.

Directional terms such as “up,” “down,” “vertical,” “horizontal,” and the like should be understood in the context of the particular object in question. For example, an object may be oriented around defined X, Y, and Z axes. In those examples, the X-Y plane will define horizontal, with up being defined as the positive Z direction and down being defined as the negative Z direction.

“Non-active” refers to a material that is electrochemically inactive and electrically nonconductive, and that does not exhibit chemical reaction or intercalation with the working ions (e.g., lithium ions) of an electrochemical device. Non-active materials in the examples below may include particles having internal porosities or conduction channels through the particles, but the particles do not chemically interact with the ions in any substantive way.

“Electrochemically active” refers to a material that is capable of chemically reacting with and/or intercalating working ions (e.g., lithium ions) of an electrochemical device. An electrochemically active material in a lithium-ion battery lithiates (i.e., stores lithium ions) and delithiates (i.e., releases lithium ions) during charging and discharging of the lithium ion battery.

“Microporous” refers to a material containing pores having diameters less than 2 nanometers (nm).

“Mesoporous” refers to a material containing pores having diameters of 2 nm to 500 nm.

“Macroporous” refers to a material containing pores having diameters greater than 500 nm.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, an electrode in accordance with the present teachings may include a first electrode layer having a first plurality of active material particles adhered together by a first binder, a second electrode layer having a second plurality of active material particles mixed with a first plurality of electrically non-conductive particles and adhered together by a second binder, and a third electrode layer (AKA separator layer) having a second plurality of electrically non-conductive particles adhered together by a third binder. The second electrode layer comprises a mixture of active material particles, such as those included in the first electrode layer, and electrically non-conductive particles, such as those included in the third electrode layer. Active material particles, such as those included in the first and second electrode layers, are electrochemically active and configured to react with working lithium ions included within an electrochemical cell including the electrode, such as through intercalation, chemical reactions, and/or the like. In contrast, electrically non-conductive particles, such as those included in the second and third electrode layers, are non-active and do not chemically interact with working lithium ions included within an electrochemical cell including the electrode. Accordingly, as the second electrode layer includes a mixture of particles having similar properties to the first electrode layer and the third electrode layer, the second electrode layer may be described as forming a gradient between the first electrode layer and the third electrode layer. In some examples, the electrode further includes one or more interlocking regions (AKA interphase regions) disposed between adjacent electrode layers, wherein the interlocking regions comprise non-planar boundary regions between the adjacent layers.

The first plurality of active material particles comprises an electrochemically active material, and may be mixed with conductive additives (AKA conductive aids), such as conductive carbon additives. Accordingly, the first electrode layer is both electrochemically active and electrically conductive. In contrast, the third electrode layer includes the second plurality of electrically non-conductive particles and includes no active material particles and no conductive additives. Accordingly, the third electrode layer is both electrically insulating and electrically non-conductive and acts as a separator for the electrode.

The second electrode layer is disposed between and directly contacting both the first electrode layer and the third electrode layer, and comprises a second plurality of active material particles mixed with a first plurality of electrically non-conductive particles. As described above, the second electrode layer forms a gradient between active regions of the electrode and insulating regions of the electrode. While the electrically non-conductive particles are both electrically non-conductive and non-active, the electrically non-conductive particles may provide ion conduction channels extending into the electrode. Working ions traveling through active material layers react (e.g., intercalate) with active material particles present within the active material layers. In general, an ion follows a path through an active material layer until it lithiates an active material particle. Working ions are likely to lithiate active material particles which are closer to the separator before lithiating portions of the electrode closer to the current collector, which may cause portions of the electrode closer to the current collector to be underutilized. In contrast, the working ions (e.g., lithium ions) do not interact, either chemically or electrically, with the electrically non-conductive particles. The electrically non-conductive particles facilitate free movement of ions through ion conduction channels disposed within and between the electrically non-conductive particles.

As the second electrode layer provides a gradual transition between the first electrode layer and the second electrode layer, ion conduction channels according to the present disclosure may extend deeper into active regions of the electrode than in electrodes which do not include the second electrode layer. In some examples, electrically non-conductive particles included in the second electrode layer may be microporous, mesoporous, and/or macroporous, providing ion conduction channels through the particles which may enable rapid ion transport through the second electrode layer. In some examples, electrically non-conductive particles included in the second electrode layer may be substantially non-porous, but may conduct ions through interstitial spaces between the particles. The first plurality of electrically non-conductive particles may additionally increase compression resistance of the second and third layers during calendering of the electrode, resulting in the electrode having a desirable density profile. In some examples, the second electrode layer includes conductive additives (AKA conductive aids), such as conductive carbon additives, and is electrically conductive. Conductive additives included in the second electrode layer reduce the impedance of the electrochemical cell for the second active material particles to participate in lithiation and/or delithiation, as the third electrode layer sufficiently electrically insulates the second electrode layer from electrical communication with an adjacent electrode.

In some examples, the first and second electrically non-conductive particles comprise a ceramic material, such as aluminum oxide (i.e., alumina (α-Al2O3)), corundum, calcined, tabular, synthetic boehmite, silicon oxides or silica, zirconia, and/or the like. The third electrode layer may be configured such that the third layer isolates the electrode (e.g., anode or cathode) from an adjacent electrode included with an electrochemical cell, while maintaining permeability to a charge carrier such as an electrolyte. Accordingly, the third electrode layer may function as an integrated separator for the electrode.

Interlocking regions disposed between the electrode layers may include non-planar interpenetrations of fingers of adjacent layers. For example, an interlocking region disposed between the first electrode layer and the second electrode layer may include a non-planar interpenetration of first fingers or protrusions of the first layer and second fingers or protrusions of the second layer, in which the first fingers and second fingers interlock. Similarly, an interlocking region disposed between the second electrode layer and the third electrode layer may include a non-planar interpenetration of third fingers or protrusions of the second layer and fourth fingers or protrusions of the third layer, in which the third fingers and the fourth fingers interlock. As the second layer is directly adjacent both the first layer and the third layer, the second fingers of the second layer extend from a side of the second layer adjacent to the first layer, and the third fingers of the second layer extend from an opposing side of the second layer adjacent to the third layer. Interlocking or interface regions created by interpenetrations between the electrode layers may reduce interfacial resistance and increase ion mobility through the electrode. The interlocking regions may further prevent crust formation on top (i.e., oriented towards the separator layer) surfaces of the first and second layers, which may impede the flow of ions between layers.

In general, a method of manufacture for an electrode including a gradated separator may include extruding composite materials on an electrically-conductive substrate. A hybrid layer comprising a mixture of active particles and separator (AKA electrically non-conductive) particles may be extruded onto an active material layer, either simultaneously with the active material layer or, in some examples, after the active material layer has been dried. Similarly, an integrated separator layer may be extruded onto the hybrid layer, either simultaneously with the hybrid layer, simultaneously with both the hybrid layer and the active material layer, or after the hybrid layer and active material layer have been dried. In some embodiments, simultaneous, near-simultaneous, or otherwise wet-on-wet extrusion of adjacent layers may be utilized to create interpenetrating finger structures at a boundary between the separator and hybrid layers and/or between the hybrid and active layers, as a result of turbulent flow at the boundary.

### Examples, Components, and Alternatives

The following sections describe selected aspects of illustrative electrodes and electrochemical cells having gradated ceramic separators as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Electrochemical Cell

This section describes an electrochemical cell including an electrode according to the present teachings. The electrochemical cell may be any bipolar electrochemical device, such as a battery (e.g., lithium-ion battery, secondary battery, etc.).

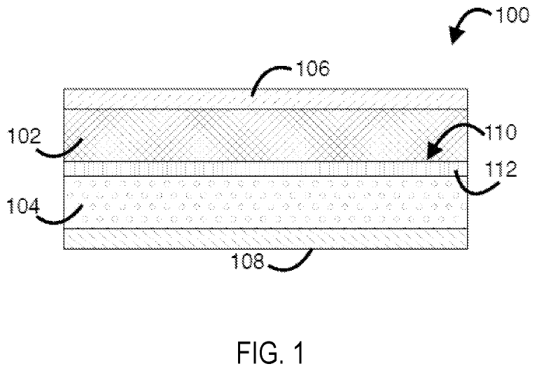

Referring now to FIG. 1., an electrochemical cell 100 is illustrated schematically in the form of a lithium-ion battery. Electrochemical cell 100 includes a positive and a negative electrode, namely a cathode 102 and an anode 104. The cathode and the anode are sandwiched between a pair of current collectors 106, 108, which may comprise metal foils or other suitable substrates. Current collector 106 is electrically coupled to cathode 102, and current collector 108 is electrically coupled to anode 104. In some examples, current collector 106 comprises aluminum foil and current collector 108 comprises copper foil. Current collectors 106 and 108 enable the flow of electrons, and therefore electrical current, into and out of each electrode. An electrolyte 110 disposed throughout the electrodes enables the transport of ions between cathode 102 and anode 104. Electrolyte 110 facilitates an ionic connection between cathode 102 and anode 104. In some examples, electrolyte 110 includes a liquid solvent and a solute of dissolved ions. In some examples, electrolyte 110 includes a gel solvent and a solute of dissolved ions. In some examples, electrolyte 110 includes a solid ion conductor intermixed with active material particles of cathode 102 and anode 104.

Electrolyte 110 is assisted by a separator 112, which physically partitions the space between cathode 102 and anode 104. Separator 112 electrically isolates cathode 102 and anode 104 from each other, preventing shorting within the electrochemical cell. Separator 112 is permeable to electrolyte 110, and enables the movement (AKA flow) of ions within electrolyte 10 and between the two electrodes. As described further below, separator 112 may be integrated within one or both of cathode 102 and anode 104. In some examples, separator 112 comprises a layer of ceramic particles applied to a top surface of an electrode (i.e., cathode 102 or anode 104), such that the ceramic particles of separator 112 are interpenetrated or intermixed with active material particles of cathode 102 or anode 104. As separator 112 insulates the electrodes from each other, ceramic particles included in separator 112 may be electrically non-conductive and electrochemically inactive. In some examples, electrolyte 110 includes a polymer gel or solid ion conductor, augmenting or replacing (and performing the function of separator 112).

Cathode 102 and anode 104 are composite structures, which comprise active material particles, binders, conductive additives (AKA conductive aids), and pores (i.e., void space) into which electrolyte 110 may penetrate. An arrangement of the constituent parts of an electrode is referred to as a microstructure, or more specifically, an electrode microstructure.

In some examples, such as when the electrode is a cathode, the binder is a polymer, e.g., polyvinylidene difluoride (PVdF), and the conductive additive typically includes a nanometer-sized carbon, such as carbon black, carbon nanotubes, micron-sized carbon (e.g. flake graphite), and/or the like. In some examples, such as when the electrode is an anode, the binder is a mixture of carboxyl-methyl cellulose (CMC) and a long chain polymer, such as styrene-butadiene rubber (SBR), polyacrylic acid (PAA), polyvinyl alcohol (PVA), and/or the like. In some examples, the conductive additive includes a carbon black, a ketjen black, a graphitic carbon, a low dimensional carbon (e.g., carbon nanotubes), and/or a carbon fiber.

Electrochemical cell 100 may include packaging (not shown). For example, packaging (e.g., a prismatic can, stainless steel tube, polymer and/or mylar pouch, etc.) may be utilized to constrain and position cathode 102, anode 104, current collectors 106 and 108, electrolyte 110, and separator 112.

In some examples, the chemistry of the active material particles differs between cathode 102 and anode 104. For example, anode 104 may include active material particles comprising graphite (artificial or natural), hard carbon, lithium metal, silicon, silicon oxide, titanate, titania, transition metals in general, elements in group 14 (e.g., carbon, silicon, tin germanium, etc.), oxides, sulfides, halides, and/or chalcogenides. On the other hand, cathode 102 may include active material particles comprising transition metals (for example, nickel, cobalt, manganese, copper, zinc, vanadium, chromium, iron), and their oxides, phosphates, phosphites, silicates, alkalines and alkaline earth metals, aluminum, aluminum oxides and aluminum phosphates, halides and/or chalcogenides.

In an electrochemical device such as electrochemical cell 100, active materials participate in an electrochemical reaction or process with a working ion to store or release energy. For example, in a lithium-ion battery, the working ions are lithium ions. For electrochemical cell 100 to properly function as a secondary battery, active material particles in both cathode 102 and anode 104 must be capable of storing and releasing ions through the respective processes known as lithiating and delithiating. Some active materials (e.g., layered oxide materials, graphitic carbon, etc.) fulfill this function by intercalating lithium ions between crystal layers or within interstitial spaces within a crystal lattice. Other active materials may have alternative lithiating and delithiating mechanisms (e.g., alloying, conversion, etc.).

When electrochemical cell 100 is being charged, anode 104 accepts lithium ions while cathode 102 donates lithium ions. In other words, lithium ions stored by the cathode travel to and are stored by the anode, lithiating the anode and delithiating the cathode. When a cell is being discharged, anode 104 donates lithium ions while cathode 102 accepts lithium ions. In other words, lithium ions stored by the anode travel to and are stored by the cathode, lithiating the cathode and delithiating the anode. Each composite electrode (i.e., cathode 102 and anode 104) has a rate at which it donates or accepts lithium ions that depends on properties extrinsic to the electrode (e.g., the current passed through each electrode, the conductivity of electrolyte 110) as well as properties intrinsic to the electrode (e.g., a solid state diffusion constant of the electrode and of active material particles in the electrode; the electrode microstructure or tortuosity; the charge transfer rate at which lithium ions move from being solvated in the electrolyte to being intercalated in the active material particles of the electrode; etc.).

During either mode of operation (charging or discharging), anode 104 or cathode 104 may donate or accept lithium ions at a limiting rate, where rate is defined as lithium ions per unit time, per unit current. For example, during charging, anode 104 may accept lithium at a first rate, and cathode 102 may donate lithium at a second rate. When the second rate is less than the first rate, the second rate of the cathode would be a limiting rate. In some examples, the differences in rates may be so dramatic as to limit the overall performance of the lithium-ion battery (e.g., cell 100). Reasons for the differences in rates may depend on an energy required to lithiate or delithiate a quantity of lithium-ions per mass of active material particles; a solid-state diffusion coefficient of lithium ions in an active material particle; and/or a particle size distribution of active material within a composite electrode. In some examples, charge and discharge rates are influenced by an impedance of the separator, which may depend on a total thickness of the separator, a particle size distribution of the separator particles, a porosity of the separator microstructure, a porosity of ceramic particles included within the separator, and/or a total density of the separator. In some examples, additional or alternative factors may contribute to the electrode microstructure and affect these rates.

### B. Illustrative Electrode with Gradated Integrated Separator

Separators included within electrochemical cells partition electrodes of opposite polarities from each other, preventing shorting between the electrodes. Separators must be electrically insulating, while also being ion-permeable, allowing for the flow of ions (e.g., lithium ions) between electrodes. An integrated separator which includes a gradient from active material particles included within an electrode layer to non-active, electrically non-conductive separator particles may provide ion channels deep within the active material portion of the electrode, facilitating rapid ion transport between electrodes.

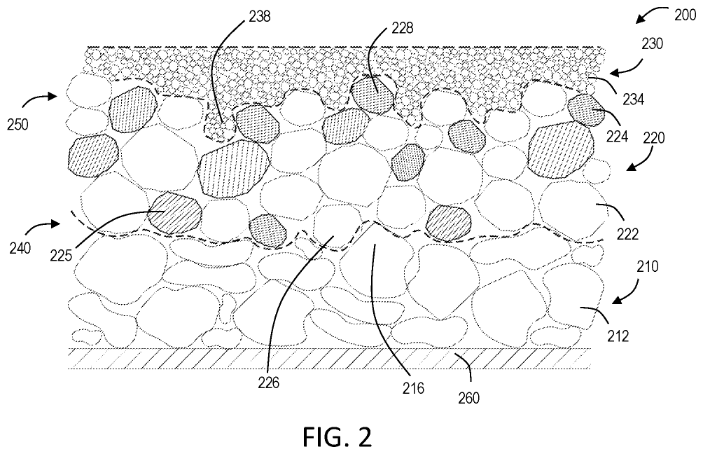

With reference to FIG. 2, an illustrative electrode 200 having a gradated integrated separator is shown. Electrode 200 is an example of an anode or cathode suitable for inclusion in an electrochemical cell, similar to cathode 102 or anode 104, described above. Electrode 200 includes a current collector substrate 260 and a plurality of electrode composite layers layered onto the current collector substrate. An active material layer (AKA first layer) 210 comprising a first plurality of active material particles 212 adhered together by a first binder is layered onto current collector substrate 260. In some examples, active material layer 210 directly contacts current collector substrate 260. In some examples, a supplemental layer is disposed between active material layer 210 and current collector substrate 260, and may augment the function of active material layer 210 (e.g., may comprise an additional active material layer) and/or current collector substrate 260 (e.g., may comprise a conductive carbon layer). A hybrid layer (AKA second layer) 220 comprising a second plurality of active material particles 222 mixed with a first plurality of inorganic separator particles 224 adhered together by a second binder is layered onto and directly contacting active material layer 210. A separator layer (AKA third layer) 230 comprising a second plurality of inorganic separator particles 234 adhered together by a third binder is layered onto and directly contacting hybrid layer 220. In some examples, a first interlocking region 240 is disposed between and adhering active material layer 210 and hybrid layer 220. In some examples, a second interlocking region 250 is disposed between and adhering hybrid layer 220 and separator layer 230.

First layer 210 is both electrically conductive and electrochemically active. Accordingly, first layer 210 comprises a first plurality of active material particles 212, which may be mixed with conductive additives (e.g., first conductive additives) and binders (e.g., the first binder) to form an active material composite. Active material particles 212 are electrochemically active, and therefore capable of chemically reacting with and/or intercalating working ions during lithiation and delithiation of the electrode. As first layer 210 is electrically conductive, first conductive additives included within first layer 210 conduct electrons between the active material particles and current collector substrate 260. In some examples, such as when the electrode is a cathode, the first binder is a polymer, e.g., polyvinylidene difluoride (PVdF), Teflon (PTFE), and/or the like, and the first conductive additives comprise nanometer-sized carbons, such as carbon black, carbon nanotubes, micron-sized carbon (e.g., flake graphite), and/or the like. In some examples, such as when the electrode is an anode, the first binder is a mixture of carboxyl-methyl cellulose (CMC) and a long chain polymer, such as styrene-butadiene rubber (SBR), polyacrylic acid (PAA), polyvinyl alcohol (PVA), and/or the like. In some examples, the first conductive additives include a carbon black, a ketjen black, a graphitic carbon, a low dimensional carbon (e.g., carbon nanotubes), a carbon fiber, and/or the like.

Second layer 220 includes both electrochemically active second active material particles 222 and electrochemically inactive and electrically non-conductive first inorganic separator particles (AKA ceramic particles) 224, which are adhered together by a second binder. Accordingly, second layer 220 may be described as a hybrid layer, combining features of active material layer 210 and separator layer 230. In some examples, the second layer is electrically conductive and includes conductive additives. In some examples, hybrid layer 220 includes both electrochemically active and conductive particles and electrochemically inactive and nonconductive particles. In some examples, such as when the electrode is a cathode, the second binder is a polymer, e.g., polyvinylidene difluoride (PVdF), Teflon (PTFE), and/or the like, and the second conductive additives comprise nanometer-sized carbons, such as carbon black, carbon nanotubes, micron-sized carbon (e.g., flake graphite), and/or the like. In some examples, such as when the electrode is an anode, the second binder is a mixture of carboxyl-methyl cellulose (CMC) and a long chain polymer, such as styrene-butadiene rubber (SBR), polyacrylic acid (PAA), polyvinyl alcohol (PVA), and/or the like. In some examples, the second conductive additives include a carbon black, a ketjen black, a graphitic carbon, a low dimensional carbon (e.g., carbon nanotubes), a carbon fiber, and/or the like. In some examples, first inorganic separator particles 224 are microporous, mesoporous, and/or macroporous, and are configured to provide conduction channels through the second layer. Second layer 220 may comprise any suitable proportions of second active material particles 222 and inorganic separator particles 224. In some examples, second layer 220 comprises between 50% and 80% active material particles, by volume and between 20 and 50% inorganic separator particles, by volume. In some examples, second layer 220 comprises between 30% and 90% active material particles by volume, and between 10% and 70% inorganic separator particles by volume. In some examples, second layer 220 comprises at least 5% active material particles by volume, and at least 5% separator particles by volume.

First ceramic particles 224 may have a greater hardness than first and second active material particles 212, 222. As a result, second layer 220 may exhibit lower levels of compressibility than first layer 210. Addition of first ceramic particles 224 to second layer 220 facilitates transfer of compressive loads imparted by calendering rolls utilized in electrode manufacturing to the first layer to preferentially compress the first layer more than the second layer. In some examples, first ceramic particles 224 have a particle size on the same order of magnitude as active material particles included in the second layer. Accordingly, in some examples, a ratio between an average particle size of the second active material particles and an average particle size of the first ceramic particles is between 0.1 and 10. In some examples, a ratio between the average particle size of the second active material particles and an average particle size of the first ceramic particles is between 0.5 and 5. In some examples, the first ceramic particles may have an average particle size from 1 to 50 μm. In some examples, the first ceramic particles may have an average particle size from 5 to 30 μm. Mixing similarly-sized active material particles and ceramic particles results in an overall electrode composite structure with a desired porosity profile throughout the thickness of the electrode. Specifically, the above configuration helps (1) induce porosity in the second layer, and (2) transfer compressive loads from the second layer to the first layer.

First ceramic particles 224 may comprise any suitable electrochemically-inactive and electrically nonconductive ceramic materials, such as aluminum oxide (i.e., alumina (α-Al₂O₃)), corundum, calcined, tabular, synthetic boehmite, silicon oxides or silica, zirconia, and/or the like. In some examples, first ceramic particles 224 comprise oxides of metals such as aluminum, silicon, titanium, magnesium, zirconium, hafnium, cerium, lanthanum, cesium, and/or the like.

In some examples, first ceramic particles 224 are microporous, mesoporous, or macroporous, facilitating a greater number of ionic conduction channels through the second layer to the first layer, e.g., for better capacity utilization upon discharge. In some examples, first ceramic particles 224 include mesoporous and/or macroporous ceramic particles, e.g., having a surface area of 5 to 1500 m²/g. As mentioned above, the ceramic particles incorporated into the second layer create ion conduction channels 225 from the third layer to the first layer for improved rate capability. As working ions (e.g., lithium ions) do not interact, either chemically or electrically, with the electrically non-conductive particles, the electrically non-conductive particles facilitate free movement of ions through ion conduction channels 225 disposed within and between the electrically non-conductive particles. Including porous, non-active ceramic particles having a similar size to the active material particles in the second layer of the electrode (anode or cathode) accomplishes a multi-functional benefit, and enhances ion conductivity to the first layer, which would naturally suffer from reduced access to working ions (e.g., lithium ions). In some examples, the first ceramic particles may have morphologies resembling agglomerates of smaller particles. This, in effect, creates a high surface area bulk that takes up more volume with less density, thereby serving a similar function as the mesoporous or macroporous particles.

In some examples, second active material particles 222 have a larger average size than first ceramic particles 224. In some examples, first ceramic particles 224 have a collective surface area that is greater than the collective surface area of second active material particles 222. In these examples, ion conduction channels within the electrode are generally provided by interstitial spaces between the first ceramic particles, such as when the first ceramic particles have morphologies resembling agglomerates of smaller particles.

In some examples, electrode 200 is an anode suitable for inclusion within an electrochemical cell. In the case of such an anode, active material particles 212, 222 may comprise graphite (artificial or natural), hard carbon, lithium metal, silicon, silicon oxide, titanate, titania, transition metals in general, elements in group 14 (e.g., carbon, silicon, tin, germanium, etc.), oxides, sulfides, transition metals, halides, chalcogenides, and/or the like.

In some examples, electrode 200 is a cathode suitable for inclusion within an electrochemical cell. In the case of such a cathode, active material particles 212, 222 may comprise transition metals (e.g., nickel, cobalt, manganese, copper, zinc, vanadium, chromium, iron, etc.), and their oxides, phosphates, phosphites, and/or silicates. In some examples, active material particles 212, 222 may comprise alkalines and alkaline earth metals, aluminum, aluminum oxides and aluminum phosphates, as well as halides and chalcogenides.

Third layer 230 is both electrochemically inactive and electrically non-conductive. Accordingly, third layer 230 may function as a separator layer for the electrode or for an electrochemical cell including electrode 200. Third layer 230 comprises a second plurality of inorganic separator particles (AKA ceramic particles) 234 adhered together by a third binder, and is configured to electrically insulate active material layer 210 and hybrid layer 220 from an adjacent electrode.

Ceramic particles 234 may have a greater hardness than active material particles 212, 222. As a result, third layer 230 may have a higher resistance to densification and a lower compressibility than both first layer 210 and second layer 220. In some examples, the third binder is a polymer, e.g., polyvinylidene difluoride (PVdF), Teflon (PTFE), and/or the like. In some examples, the third binder is a mixture of carboxyl-methyl cellulose (CMC) and a long chain polymer, such as styrene-butadiene rubber (SBR), polyacrylic acid (PAA), polyvinyl alcohol (PVA), and/or the like. Third layer 230 may have any thickness which facilitates ionic conduction while electrically insulating the electrode. As the thickness of third layer 230 increases, an impedance of an electrochemical cell including electrode 200 increases. In some examples, third layer 230 may have a thickness from 1 to 50 μm. In some examples, ceramic particles 234 have a smaller average size than second active material particles 222.

Third layer 230 may comprise varying mass fractions of inorganic particles (e.g., ceramic particles) and varying mass fractions of binders and other additives. In some examples, the third layer comprises from 50% to 99% inorganic material. In some examples, the third layer comprises greater than 99% inorganic material and less than 1% binder. In examples comprising greater than 99% inorganic material, the electrode may be manufactured in a similar fashion to electrodes with third layers having lower percentages of inorganic material, optionally followed by ablation of excess binder during post-processing.

In some examples, the third layer comprises less than 50% inorganic material and greater than 50% binder, by mass. In these cases, the binder may comprises a coblocked polymer such as a polyamide, polyethylene, polypropylene, polyolefin, and/or any combination of suitable polymers with a porous structure. The binder may comprise a first and second polypropylene layer and a polyethylene layer intermediate the polypropylene layers. This high-binder content configuration may function as a “shutdown” mechanism for the electrode. For example, the polyethylene layer may melt or collapse at high temperatures (e.g., in a catastrophic failure, fire, etc.), thus stopping ionic and electrical conduction and improving device safety. On the other hand, high-binder embodiments may decrease calendering advantages seen in third layers with higher fractions of inorganic material.

In some examples, an additional polyolefin separator may be added onto a top surface of the third layer, augmenting the function of third layer 230.

In some examples, a first interlocking region 240 is disposed between and adhering active material layer 210 and hybrid layer 220. In some examples, a second interlocking region 250 is disposed between and adhering hybrid layer 220 and separator layer 230. First interlocking region 240 includes a non-planar boundary between active material layer 210 and hybrid layer 220. Active material layer 210 and hybrid layer 220 have respective, three-dimensional, interpenetrating fingers 216, 226 that interlock the two layers together, forming a mechanically robust interface that is capable of withstanding stresses, such as those due to electrode expansion and contraction. Similarly, second interlocking region 250 includes a non-planar boundary between hybrid layer 220 and second separator layer 230. Hybrid layer 220 and separator layer 230 have respective, three-dimensional, interpenetrating fingers 228, 238 that interlock the two layers together, forming a mechanically robust interface that is capable of withstanding stresses, such as those due to electrode expansion and contraction and separator shrinking.

Fingers 238 of separator layer 230 extend into hybrid layer 220, providing ion channels into the hybrid layer. First ceramic particles 224 may provide an extension of fingers 238, extending ion channels further into the active material bulk of the electrode.

When portions of electrode 200 are lithiating or delithiating, electrode 200 remains coherent, and the first layer and the second layer remain bound by interlocking region 240. Similarly, the second layer and the third layer remain bound by interlocking region 250. In general, the interdigitation or interpenetration of respective fingers, as well as the increased surface area of the interphase boundary, function to adhere the two zones together.

In one example, electrode 200 is a cathode suitable for inclusion in a lithium-ion cell. In this example, during charging of the lithium-ion cell, active material particles 212, 222 delithiate. During this process, the active material particles may contract, causing active material layer 210 and hybrid layer 220 to contract. In contrast, during discharging of the cell, the active material particles lithiate and swell, causing active material layer 210 and hybrid layer 220 to swell. In some examples, hybrid layer 220 may swell and contract to a lesser degree than active material layer 210, as hybrid layer 220 comprises a lower proportion of active material particles by weight than the active material layer.

In an alternate example, electrode 200 is an anode suitable for inclusion in a lithium-ion cell. In this example, during charging of the lithium-ion cell, active material particles 212, 222 lithiate. During this process, the active material particles may swell, causing active material layer 210 and hybrid layer 220 to swell. In contrast, during discharging of the cell, active material particles 212, 222 delithiate and contract, causing contraction of active material layer 210 and hybrid layer 220. In some examples, hybrid layer 220 may swell and contract to a lesser degree than active material layer 210, as hybrid layer 220 comprises a lower proportion of active material particles by weight than the active material layer.

Interlocking regions 240, 250 may comprise networks of fluid passageways defined by active material particles, ceramic particles, binder, conductive additives, and/or additional layer components. These fluid passages are not hampered by calendering-induced changes in mechanical or morphological states of the particles due to the non-planar boundary included in the interlocking regions. In contrast, a substantially planar boundary is often associated with the formation of a crust layer upon subsequent calendering. Such a crust layer is disadvantageous as it can significantly impede ion conduction through the interlocking region. Furthermore, such a crust layer also represents a localized compaction of active material particles that effectively results in reduced pore volumes within the electrode. This may be an issue of particular importance for anodes, as solid electrolyte interphase (SEI) film buildup on active material particles clogs pores included within the electrode at a quicker rate, leading to lithium plating and decreased safety and cycle life of the electrode.

An anode with a gradated integrated separator according to the present disclosure may experience additional benefits over alternative electrode forms. As anodes may include active material particles with comparatively larger average particle size than other electrodes (e.g., cathodes), anodes may experience increased compressibility from simultaneous calendering with an integrated separator layer. As ceramic separator particles may have a hardness greater than a hardness of the anode active material particles and therefore a greater resistance to densification during a calendering process, the ceramic separator layer may transfer compressive loads to the anode layer disposed beneath the ceramic separator layer and the hybrid layer.

### C. Illustrative Interlocking Region

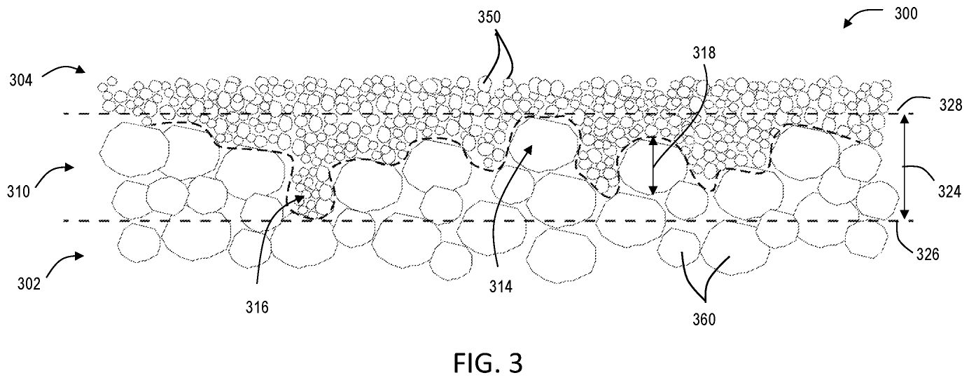

As described below and shown in FIG. 3, this section describes an illustrative interlocking region 310 suitable for use in the electrode of FIG. 2. Interlocking region 240 and interlocking region 250 may be substantially identical to interlocking region 310, except as otherwise described.

Interlocking region 310 includes a non-planar boundary between first layer 302 and second layer 304. First layer 302 and second layer 34 may correspond to any suitable layers included in a multilayered electrode. For example, first layer 302 may correspond to active material layer 210 of electrode 200, and second layer 304 may correspond to hybrid layer 220 of electrode 200. Similarly, first layer 302 may correspond to hybrid layer 220 of electrode 200, and second layer 304 may correspond to separator layer 230 of electrode 200.

First layer 302 and second layer 304 have respective, three-dimensional, interpenetrating fingers 314 and 316 that interlock the two layers together, forming a mechanically robust interface that is capable of withstanding stresses, such as those due to electrode expansion and contraction, and due to separator shrinking. Additionally, the non-planar surfaces defined by fingers 314 and fingers 316 represent an increased total surface area of the interface boundary, which may provide reduced interfacial resistance and may increase ion mobility through the electrode. Fingers 314 and 316 may be interchangeably referred to as fingers, protrusions, extensions, projections, and/or the like. Furthermore, the relationship between fingers 314 and 316 may be described as interlocking, interpenetrating, intermeshing, interdigitating, interconnecting, interlocking, and/or the like.

Finger 314 and fingers 316 are a plurality of substantially discrete interpenetrations, wherein fingers 314 are generally made up of a first plurality of particles 340 and fingers 316 are generally made up of a second plurality of particles 350. For example, fingers 314 may be generally made up of first active material particles 212 and fingers 316 may be generally made up of second active material particles 222 and first ceramic particles 224. Similarly, fingers 314 may be generally made up of second active material particles 222 and first ceramic particles 224 and fingers 316 may be generally made up of second ceramic particles 234. The fingers are three-dimensionally interdigitated, analogous to an irregular form of the stud-and-tube construction of Lego bricks. Accordingly, fingers 314 and 316 typically do not span the electrode in any direction, such that a cross section perpendicular to that of FIG. 3 will also show a non-planar, undulating boundary similar to the one shown in FIG. 3. Interlocking region 310 may alternatively be referred to as a non-planar interpenetration of first layer 302 and second layer 304, including fingers 314 interlocked with fingers 316.

As shown in FIG. 3, although fingers 314 and 316 may not be uniform in size or shape, the fingers may have an average or typical length 318. In some examples, length 318 of fingers 314 and 316 may fall in a range between two and five times the average particle size of the first layer or the second layer, whichever is smaller. In some examples, length 318 of fingers 314, 316 may fall in a range between six and ten times the average particle size of the first layer or the second layer, whichever is smaller. In some examples, length 318 of fingers 314, 316 may fall in a range between eleven and fifty times the average particle size of the first layer or the second layer, whichever is smaller. In some examples, length 318 of fingers 314, 316 may be greater than fifty times the average particle size of the first layer or the second layer, whichever is smaller.

In some examples, length 318 of fingers 314 and 316 may fall in a range of approximately five hundred to approximately one thousand nanometers. In some examples, length 318 of fingers 314 and 316 may fall in a range of approximately one to approximately five μm. In some examples, length 318 of fingers 314 and 316 may fall in a range from approximately six to approximately ten μm. In some examples, length 318 of fingers 314 and 316 may fall in a range from approximately eleven to approximately fifty μm. In some examples, length 318 of fingers 314 and 316 may be greater than approximately fifty μm.

In the present example, a total thickness 324 of interlocking region 310 is defined by the level of interpenetration between the two electrode material layers (first layer 302 and second layer 304). A lower limit 326 may be defined by the lowest point reached by second layer 304 (i.e., by fingers 316). An upper limit 328 may be defined by the highest point reached by first layer 302 (i.e., by fingers 314). Total thickness 324 of interlocking region 310 may be defined as the separation or distance between limits 326 and 328. In some examples, the total thickness of interlocking region 310 may fall within one or more of various relative ranges, such as from approximately 200% (2×) to approximately 500% (5×), approximately 500% (5×) to approximately 1000% (10×), approximately 1000% (10×) to approximately 5000% (50×), and/or greater than approximately 5000% (50×) of the average particle size of the first layer or the second layer, whichever is smaller.

In some examples, total thickness 324 of interlocking region 310 may fall within one or more of various absolute ranges, such as from approximately five hundred and one thousand nanometers, from approximately one to approximately ten μm, from approximately ten to approximately fifty μm, and/or greater than approximately fifty μm.

In the example depicted in FIG. 3, first particles 340 in first layer 302 have a greater average distribution of volumes than an average distribution of volumes of second particles 350 in second layer 304 (i.e., a larger average size). In some examples, first particles 340 have a collective surface area that is less than the collective surface area of second particles 350. Alternatively, first particles 340 in first layer 302 have a smaller average distribution of volumes than an average distribution of volumes of second particles 350 in second layer 304 (i.e., a smaller average size). In some examples, first particles 340 have a collective surface area that is greater than the collective surface area of second particles 350. In some examples, first particles 340 and second particles 350 have similar average sizes (e.g., on a same order of magnitude).

In the present example, first particles 340 and second particles 350 are substantially spherical in particle morphology. In other examples, any subset of the plurality of particles in either the active material layer, the hybrid layer, or the separator layer may have particle morphologies that are: spherical, flake-like, platelet-like, irregular, potato-shaped, oblong, fractured, agglomerates of smaller particle types, and/or a combination of the above.

### D. Illustrative Electrochemical Cell

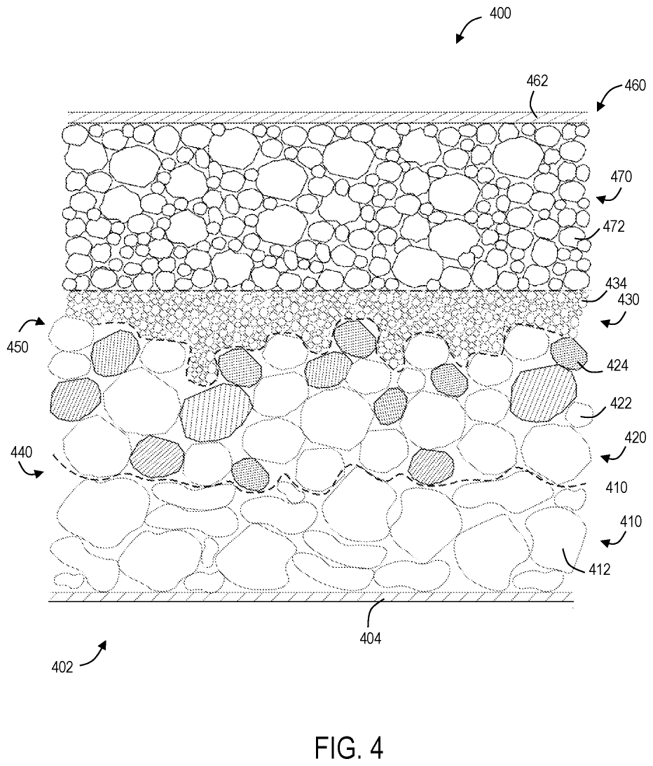

As shown in FIG. 4, this section describes an illustrative electrochemical cell 400 including a gradated integrated separator. Electrochemical cell 400 includes an electrode 402 including a gradated integrated separator, such as electrode 200, described above, and an electrode 460 having an opposite polarity to electrode 402 disposed adjacent to separator layer 430.

Electrode 402 is an example of electrode 200, as described above, and accordingly includes a current collector substrate 404 and a plurality of electrode composite layers layered onto the current collector substrate. Electrode 402 is substantially identical to electrode 200, except as otherwise described. An active material layer (AKA first layer) 410 comprising a first plurality of active material particles 412 adhered together by a first binder is layered onto current collector substrate 404. A hybrid layer (AKA second layer) 420 comprising a second plurality of active material particles 422 mixed with a first plurality of inorganic separator particles 424 adhered together by a second binder is layered onto and directly contacting active material layer 410. A separator layer (AKA third layer) 430 comprising a second plurality of inorganic separator particles 434 adhered together by a third binder is layered onto and directly contacting hybrid layer 420. In some examples, a first interlocking region 440 is disposed between and adhering active material layer 410 and hybrid layer 420. In some examples, a second interlocking region 450 is disposed between and adhering hybrid layer 420 and separator layer 430.

First layer 410 is both electrically conductive and electrochemically active. Accordingly, first layer 410 comprises a first plurality of active material particles 412, which may be mixed with conductive additives (e.g., first conductive additives) and binders (e.g., the first binder) to form an active material composite. In some examples, such as when the electrode is a cathode, the first binder is a polymer, e.g., polyvinylidene difluoride (PVdF), Teflon (PTFE), and/or the like, and the first conductive additives comprise nanometer-sized carbons, such as carbon black, carbon nanotubes, micron-sized carbon (e.g., flake graphite), and/or the like. In some examples, such as when the electrode is an anode, the first binder is a mixture of carboxyl-methyl cellulose (CMC) and a long chain polymer, such as styrene-butadiene rubber (SBR), polyacrylic acid (PAA), polyvinyl alcohol (PVA), and/or the like. In some examples, the first conductive additives include a carbon black, a ketjen black, a graphitic carbon, a low dimensional carbon (e.g., carbon nanotubes), a carbon fiber, and/or the like.

Second layer 420 includes both electrochemically active second active material particles 422 and electrochemically inactive and electrically non-conductive first inorganic separator particles (AKA ceramic particles) 424, which are adhered together by a second binder. Accordingly, second layer 420 may be described as a hybrid layer, combining features of active material layer 410 and separator layer 430. In some examples, the second layer is electrically conductive and includes conductive additives. In some examples, hybrid layer 220 includes both electrochemically active and conductive particles and electrochemically inactive and nonconductive particles. In some examples, such as when the electrode is a cathode, the second binder is a polymer, e.g., polyvinylidene difluoride (PVdF), Teflon (PTFE), and/or the like, and the second conductive additives comprise nanometer-sized carbons, such as carbon black, carbon nanotubes, micron-sized carbon (e.g., flake graphite), and/or the like. In some examples, such as when the electrode is an anode, the second binder is a mixture of carboxyl-methyl cellulose (CMC) and a long chain polymer, such as styrene-butadiene rubber (SBR), polyacrylic acid (PAA), polyvinyl alcohol (PVA), and/or the like. In some examples, the second conductive additives include a carbon black, a ketjen black, a graphitic carbon, a low dimensional carbon (e.g., carbon nanotubes), a carbon fiber, and/or the like. In some examples, first inorganic separator particles 424 are microporous, mesoporous, and/or macroporous, and are configured to provide conduction channels through the second layer. First ceramic particles 424 may comprise any suitable electrochemically-inactive and electrically nonconductive ceramic materials, such as aluminum oxide (i.e., alumina (α-Al₂O₃)), corundum, calcined, tabular, synthetic boehmite, silicon oxides or silica, zirconia, and/or the like. In some examples, first ceramic particles 424 comprise oxides of metals such as aluminum, silicon, titanium, magnesium, zirconium, hafnium, cerium, lanthanum, cesium, and/or the like.

In some examples, first ceramic particles 424 are microporous, mesoporous, or macroporous, facilitating a greater number of ionic conduction channels through the second layer to the first layer, e.g., for better capacity utilization upon discharge. In some examples, first ceramic particles 424 include mesoporous and/or macroporous ceramic particles, e.g., having a surface area of 5 to 1500 m²/g. In some examples, the first ceramic particles may have morphologies resembling agglomerates of smaller particles.

In some examples, second active material particles 422 have a larger average size than first ceramic particles 424. In some examples, first ceramic particles 424 have a collective surface area that is greater than the collective surface area of second active material particles 422. In these examples, ion conduction channels within the electrode are generally provided by interstitial spaces between the first ceramic particles, such as when the first ceramic particles have morphologies resembling agglomerates of smaller particles.

In some examples, electrode 402 is an anode. In the case of such an anode, active material particles 412, 422 may comprise graphite (artificial or natural), hard carbon, lithium metal, silicon, silicon oxide, titanate, titania, transition metals in general, elements in group 14 (e.g., carbon, silicon, tin, germanium, etc.), oxides, sulfides, transition metals, halides, chalcogenides, and/or the like.

In some examples, electrode 402 is a cathode. In the case of such a cathode, active material particles 412, 422 may comprise transition metals (e.g., nickel, cobalt, manganese, copper, zinc, vanadium, chromium, iron, etc.), and their oxides, phosphates, phosphites, and/or silicates. In some examples, active material particles 412, 422 may comprise alkalines and alkaline earth metals, aluminum, aluminum oxides and aluminum phosphates, as well as halides and chalcogenides.

Third layer 430 is both electrochemically inactive and electrically non-conductive. Accordingly, third layer 430 may function as a separator layer for electrochemical cell 400, and may electrically insulate electrode 402 from electrode 460. Third layer 430 comprises a second plurality of inorganic separator particles (AKA ceramic particles) 434 adhered together by a third binder, and is configured to electrically insulate active material layer 410 and hybrid layer 420 from an electrode 460. In some examples, the third binder is a polymer, e.g., polyvinylidene difluoride (PVdF), Teflon (PTFE), and/or the like. In some examples, the third binder is a mixture of carboxyl-methyl cellulose (CMC) a long chain polymer, such as styrene-butadiene rubber (SBR), polyacrylic acid (PAA), polyvinyl alcohol (PVA), and/or the like. Third layer 430 may have any thickness which facilitates ionic conduction while electrically insulating electrode 402 from electrode 460. As the thickness of third layer 430 increases, an impedance of electrochemical cell 400 increases. In some examples, third layer 430 may have a thickness from 1 to 50 μm.

In some examples, an additional polyolefin separator may be added onto a top surface of the third layer, augmenting the function of the third layer.

In some examples, a first interlocking region 440 is disposed between and adhering active material layer 410 and hybrid layer 420. In some examples, a second interlocking region 450 is disposed between and adhering hybrid layer 420 and separator layer 430. First interlocking region 440 includes a non-planar boundary between active material layer 410 and hybrid layer 420. As described above with respect to FIGS. 2 and 3, active material layer 410 and hybrid layer 420 have respective, three-dimensional, interpenetrating fingers that interlock the two layers together, forming a mechanically robust interface that is capable of withstanding stresses, such as those due to electrode expansion and contraction. Similarly, second interlocking region 450 includes a non-planar boundary between hybrid layer 420 and second separator layer 430. Hybrid layer 420 and separator layer 430 have respective, three-dimensional, interpenetrating fingers that interlock the two layers together, forming a mechanically robust interface that is capable of withstanding stresses, such as those due to electrode expansion and contraction and separator shrinking.

Electrode 460 is disposed on and in contact with separator layer 430. Electrode 460 may include an active material composite 470 including a third plurality of active material particles 472 adhered together by a fourth binder. Active material particles 472 have an opposite polarity to active material particles 412, 422 included in electrode 402. Accordingly, if electrode 402 is an anode, electrode 460 is a cathode and active material particles 472 may comprise transition metals (e.g., nickel, cobalt, manganese, copper, zinc, vanadium, chromium, iron, etc.), and their oxides, phosphates, phosphites, and/or silicates. In some examples, active material particles 472 may comprise alkalines and alkaline earth metals, aluminum, aluminum oxides and aluminum phosphates, as well as halides and chalcogenides. Similarly, if electrode 402 is a cathode, electrode 460 is an anode and active material particles 472 may comprise graphite (artificial or natural), hard carbon, lithium metal, silicon, silicon oxide, titanate, titania, transition metals in general, elements in group 14 (e.g., carbon, silicon, tin, germanium, etc.), oxides, sulfides, transition metals, halides, chalcogenides, and/or the like. In some examples, the fourth binder is a polymer, e.g., polyvinylidene difluoride (PVdF), Teflon (PTFE), and/or the like. In some examples, the fourth binder is a mixture of carboxyl-methyl cellulose (CMC) and a long chain polymer, such as styrene-butadiene rubber (SBR), polyacrylic acid (PAA), polyvinyl alcohol (PVA), and/or the like. A second current collector 462 is disposed on and contacting electrode 460. Second current collector 462 may comprise any suitable substrate, such as copper foil, aluminum foil, and/or the like, and may be electrically coupled to electrode 460.

### E. Illustrative Electrode Manufacturing Method

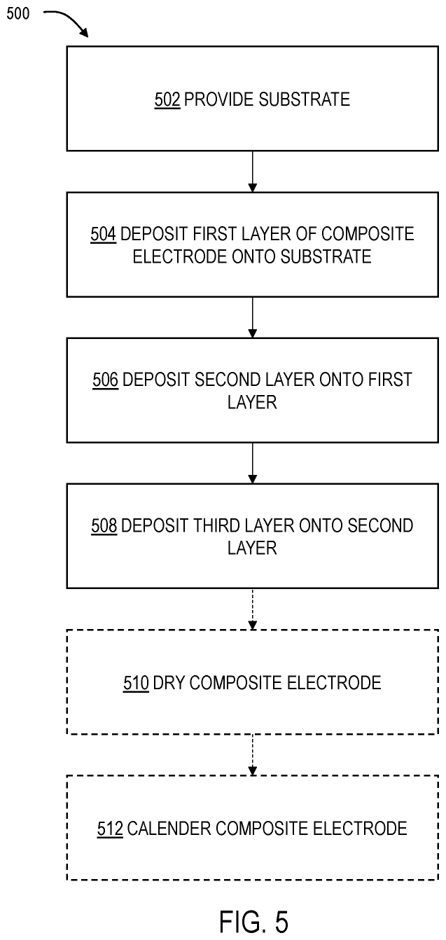

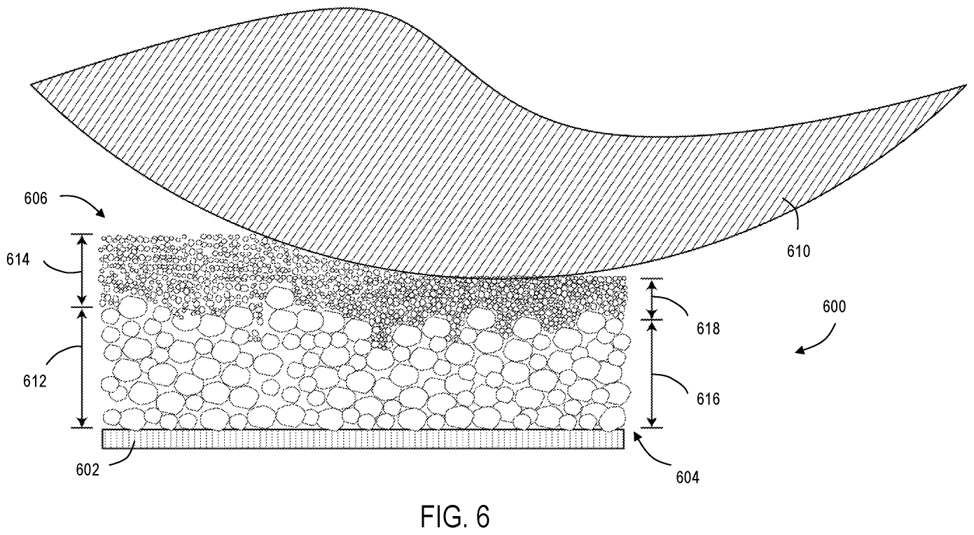

This section describes steps of an illustrative method 500 for manufacturing an electrode including a gradated integrated separator, see FIGS. 5 and 6. Aspects of electrode 200, interlocking region 310, and electrochemical cell 400 may be utilized in the method steps described below. Where appropriate, reference may be made to components and systems that may be used in carrying out each step. These references are for illustration, and are not intended to limit the possible ways of carrying out any particular step of the method.

FIG. 5 is a flowchart illustrating steps performed in an illustrative method, and may not recite the complete process or all steps of the method. Although various steps of method 500 are described below and depicted in FIG. 5, the steps need not necessarily all be performed, and in some cases may be performed simultaneously, or in a different order than the order shown.

Step 502 of method 500 includes providing a substrate, wherein the substrate includes any suitable structure and material configured to function as a conductor in a secondary battery of the type described herein. In some examples, the substrate comprises a current collector. In some examples, the substrate comprises a metal foil. The term “providing” here may include receiving, obtaining, purchasing, manufacturing, generating, processing, preprocessing, and/or the like, such that the substrate is in a state and configuration for the following steps to be carried out. In some examples, providing a substrate includes loading the substrate onto a backing roll.

Method 500 next includes a plurality of steps in which at least a portion of the substrate is coated with an electrode material composite. This may be done by causing a current collector substrate and an electrode material composite dispenser to move relative to each other, by causing the substrate to move past an electrode material composite dispenser (or vice versa) that coats the substrate as described below. The composition of material particles in each electrode material composite layer may be selected to achieve the benefits, characteristics, and results described herein. The electrode material composite may include on or more electrode layers, each including a plurality of active material particles, and one or more separator layers, each including a plurality of inorganic material particles.

Step 504 of method 500 includes coating a first layer of a composite electrode on a first side of the substrate. In some examples, the first layer includes a plurality of first particles adhered together by a first binder, the first particles having a first average particle size (or other first particle distribution). In this example, the plurality of first particles may comprise a plurality of first active material particles mixed with first conductive additives, and the first layer may be described as an active material layer. The first layer is electrochemically active and electrically conductive. Accordingly, the plurality of first particles are capable of chemically interacting with and/or intercalating working ions included within the electrode. In some examples, such as when the electrode is a cathode, the first binder is a polymer, e.g., polyvinylidene difluoride (PVdF), Teflon (PTFE), and/or the like, and the first conductive additives comprise nanometer-sized carbons, such as carbon black, carbon nanotubes, micron-sized carbon (e.g., flake graphite), and/or the like. In some examples, such as when the electrode is an anode, the first binder is a mixture of carboxyl-methyl cellulose (CMC) and a long chain polymer, such as styrene-butadiene rubber (SBR), polyacrylic acid (PAA), polyvinyl alcohol (PVA), and/or the like. In some examples, the first conductive additives include a carbon black, a ketjen black, a graphitic carbon, a low dimensional carbon (e.g., carbon nanotubes), a carbon fiber, and/or the like.

In some examples, the composite electrode is an anode suitable for inclusion within an electrochemical cell. In this case, the first particles may comprise graphite (artificial or natural), hard carbon, lithium metal, silicon, silicon oxide, titanate, titania, transition metals in general, elements in group 14 (e.g., carbon, silicon, tin, germanium, etc.), oxides, sulfides, transition metals, halides, and/or chalcogenides. In some examples, the composite electrode is a cathode suitable for inclusion within an electrochemical cell. In this case, the first particles may comprise transition metals (for example, nickel, cobalt, manganese, copper, zinc, vanadium, chromium, iron, etc.), and their oxides, phosphates, phosphites and silicates; alkalines and alkaline earth metals; aluminum, aluminum oxides and aluminum phosphates; halides; chalcogenides, and/or the like.

The coating process of step 504 (and steps 506, 508) may include any suitable coating method(s), such as slot die, blade coating, spray-based coating, electrostatic jet coating, and/or the like. In some examples, the first layer is coated as a wet slurry of solvent (e.g., water, NMP (N-Methyl-2-pyrrolidone), binder, conductive additive, and first particles. In some examples, the first layer is coated dry, as a plurality of first particles mixed with a binder and/or conductive additive. Step 504 may optionally include drying the first layer of the composite electrode.

Step 506 of method 500 includes coating a second layer onto the first layer, forming a multilayered (e.g., stratified) structure. The second layer may include a plurality of second particles adhered together by a second binder, the second particles having a second average particle size (or other second particle distribution). In this example, the second layer comprises a plurality of second active material particles and a plurality of first inorganic separator particles mixed with second conductive additives, and may be described as a hybrid layer combining features of an active material layer and a separator layer. Accordingly, the second layer may be both electrochemically active and electrically conductive and the plurality of second active material particles are capable of chemically interacting with and/or intercalating working ions included within the electrode. The plurality of first inorganic separator particles may be configured to provide ion conduction channels through the second layer, and to increase resistance to densification of the second layer. In some examples, as described above, the composite electrode is an anode suitable for inclusion within an electrochemical cell. In this case, the second active material particles may comprise graphite (artificial or natural), hard carbon, lithium metal, silicon, silicon oxide, titanate, titania, transition metals in general, elements in group 14 group 14 (e.g., carbon, silicon, tin, germanium, etc.), oxides, sulfides, transition metals, halides, and/or chalcogenides. In some examples, the composite electrode is a cathode suitable for inclusion within an electrochemical cell. In this case, the second active material particles may comprise transition metals (for example, nickel, cobalt, manganese, copper, zinc, vanadium, chromium, iron, etc.), and their oxides, phosphates, phosphites and silicates; alkalines and alkaline earth metals; aluminum, aluminum oxides and aluminum phosphates; halides; chalcogenides, and/or the like. The plurality of first inorganic separator particles may comprise ceramic particles, such as aluminum oxide (i.e., alumina (α-Al₂O₃)), corundum, calcined, tabular, synthetic boehmite, silicon oxides or silica, zirconia, and/or the like. In some examples, the plurality of first inorganic separator particles includes ceramic particles that are microporous, mesoporous, or macroporous, facilitating a greater number of ionic conduction channels through the second layer to the first layer, e.g., for better capacity utilization upon discharge. In some examples, such as when the electrode is a cathode, the second binder is a polymer, e.g., polyvinylidene difluoride (PVdF), Teflon (PTFE), and/or the like, and the second conductive additives comprise nanometer-sized carbons, such as carbon black, carbon nanotubes, micron-sized carbon (e.g., flake graphite), and/or the like. In some examples, such as when the electrode is an anode, the second binder is a mixture of carboxyl-methyl cellulose (CMC) and a long chain polymer, such as styrene-butadiene rubber (SBR), polyacrylic acid (PAA), polyvinyl alcohol (PVA), and/or the like. In some examples, the second conductive additives include a carbon black, a ketjen black, a graphitic carbon, a low dimensional carbon (e.g., carbon nanotubes), a carbon fiber, and/or the like.

Step 508 of method 500 includes coating a third layer onto the second layer. The third layer may include a plurality of third particles adhered together by a third binder, the third particles having a third average particle size (or other third particle distribution). In this example, the third layer comprises a second plurality of inorganic separator particles configured to function as a separator for the electrode, and the third layer may be referred to as a separator layer. Accordingly, the third layer may be electrochemically inactive and electrically non-conductive, and may electrically insulate the electrode. In some examples, the third layer may comprise ceramic particles, such as aluminum oxide (i.e., alumina (α-Al₂O₃)), corundum, calcined, tabular, synthetic boehmite, silicon oxides or silica, zirconia, and/or the like. The third binder may comprise any suitable binder for an electrode composite, such as polymers (e.g., polyvinylidene difluoride (PVdF), Teflon (PTFE)), carboxyl-methyl cellulose (CMC), long chain polymers (e.g., tyrene-butadiene rubber (SBR), polyacrylic acid (PAA), polyvinyl alcohol (PVA), etc.), and/or the like.

In some examples, steps 504, 506, and 508 may be performed substantially simultaneously. For example, the three slurries may be extruded through their respective orifices simultaneously. In some examples, steps 504 and step 506 may be performed substantially simultaneously. For example, the first layer and the second layer may be extruded through their respective orifices simultaneously. In some examples, the third layer may be coated onto the second layer after the first layer and the second layer are coated. In some examples, the first layer and the second layer may be coated wet (e.g., using a slot-die) and the third layer may be coated dry (e.g., by spraying).

Simultaneous extrusion of slurries forms a multi-layered slurry bead and coating on the moving substrate. In some examples, differences in viscosities, differences in surface tensions, differences in densities, differences in solid contents, and/or different solvents used between the first slurry and the second slurry may be tailored to cause interpenetrating finger structures at the boundary between the two composite layers. Similarly, in some examples, differences in viscosities, differences in surface tensions, differences in densities, differences in solid contents, and/or different solvents used between the second slurry and the third slurry may be tailored to cause interpenetrating finger structures at the boundary between the two composite layers. In some examples, the viscosities, surface tensions, densities, solids contents, and/or solvents may be substantially similar. Creation of interpenetrating structures, if desired, may be facilitated by turbulent flow at the wet interface between the first active material slurry and the hybrid slurry, or between the hybrid slurry and the separator slurry, creating partial intermixing of the two slurries. As the second layer (AKA hybrid layer) includes a mixture of inorganic separator particles and active material particles, interpenetrations between the second layer and the third layer may result in interpenetrating structures (e.g., fingers) extending deep into the electrode. In examples wherein the first inorganic separator particles are microporous, mesoporous, or macroporous, ceramic particles of the second layer may provide ion conduction channels which extend deep into the electrode.

To facilitate proper curing in the drying process, the first layer (closest to the current collector) may be configured (in some examples) to be dried from solvent prior to the second layer (further from the current collector) so as to avoid creating skin-over effects and blusters in the resulting dried coatings. To facilitate proper curing in the drying process, the second layer may be configured (in some examples) to be dried from solvent prior to the third layer (further from the current collector) so as to avoid creating skin-over effects and blisters in the resulting dried coatings.

In some examples, any of the described steps may be repeated to form four or more layers. For example, an additional layer or layer may include active materials to form a multilayered electrode structure before adding the separator layer. Any method described herein to impart structure between adjacent layers may be utilized to form similar structures between any additional layers deposited during the manufacturing process.

Method 500 may optionally include drying the composite electrode in step 510. The first, second, and third layers may experience the drying process as a combined structure. In some examples, drying step 510 includes a form of heating and energy transport to and from the electrode (e.g., convection, conduction, radiation) to expedite the drying process. In some examples, drying step 510 includes causing the coated current collector substrate to move relative to a plurality of heating elements. In some examples, drying step 510 includes moving the coated current collector substrate through an oven, furnace, or other enclosed heating environment.

Method 500 may optionally include calendering the composite electrode in step 512. The first, second, and third layers may experience the calendering process as a combined structure. In some examples, calendering is replaced with another compression, pressing, or compaction process. In some examples, calendering the electrode may be performed by pressing the combined first, second, and third layers against the substrate, such that electrode density is increased in a non-uniform manner, with the first layer having a first porosity, the second layer having a second porosity, and the third layer having a third porosity. The second porosity may be lower than the first porosity and greater than the third porosity. In some examples, calendering the composite electrode further includes heating the composite electrode, such that binders included in the composite electrode coalesce.

In some examples, step 510 and step 512 may be combined (e.g., in a hot roll calendering process).

FIG. 6 shows an electrode undergoing a calendering process, in which particles in a second layer 606 can be calendered with a first layer 604. This may prevent a “crust” formation on the electrode, specifically on the first layer. A similar process may apply to a tri-layered electrode, such as the electrode manufactured in method 500. A roller 610 may apply pressure to a fully assembled electrode 600. Electrode 600 may include first layer 604 and second layer 606 applied to a substrate web 602. First layer 604 may have a first uncompressed thickness 612 and second layer 606 may have a second uncompressed thickness 614 prior to calendering. After the electrode has been calendered, first layer 604 may have a first compressed thickness 616 and second layer 606 may have a second compressed thickness 618. In some examples, second layer 606 may have a greater resistance to densification and a lower compressibility than first layer 604. After a certain level of densification, a higher tolerance to bulk compression of the second layer may transfer a load to the more compressible first layer below. This process may effectively densify the first layer (e.g., an active material layer) without over densifying the second layer (e.g., a separator layer).

### F. Illustrative Manufacturing Systems

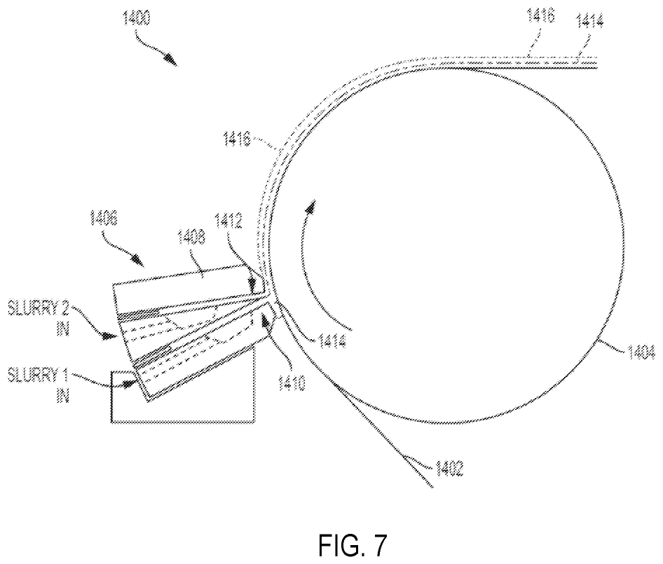

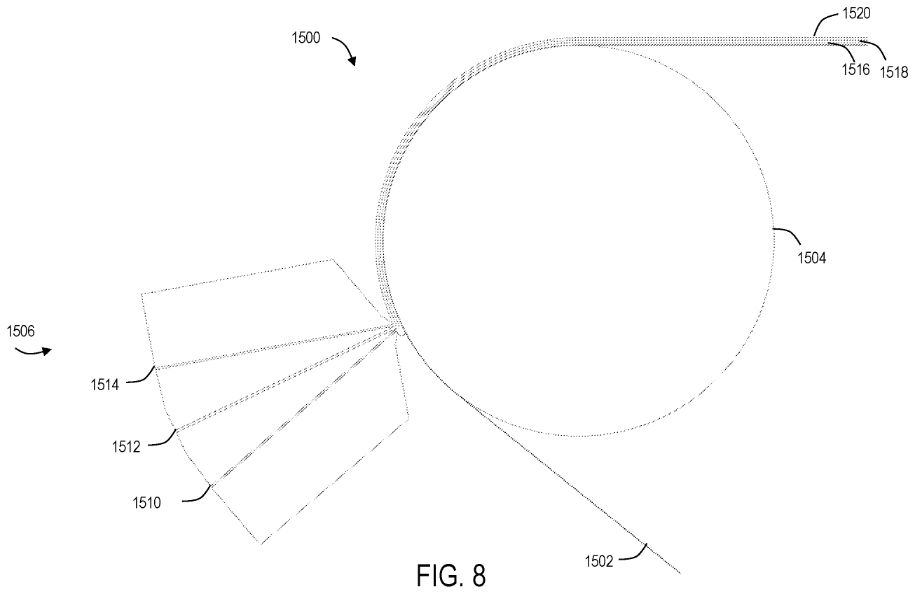

Turning to FIGS. 7 and 8, illustrative manufacturing systems 1400 and 1500 for use with method 500 will now be described. Illustrative manufacturing system 1400, as depicted in FIG. 7, includes a slot-die coating head with at least two fluid slots, fluid cavities, fluid lines, and fluid pumps, which may be utilized to manufacture a battery electrode including multiple layers (e.g., an electrode including an active material layer, a hybrid layer, and an integrated separator layer). In some examples, additional cavities may be utilized to create additional layers.

In system 1400, a foil substrate 1402 is transported by a revolving backing roll 1404 past a stationary dispenser device 1406. Dispenser device may include any suitable dispenser configured to evenly coat one or more layers of slurry onto the substrate. In some examples, the substrate may be held stationary while the dispenser head moves. In some examples, both the substrate and the dispenser head may be in motion. Dispenser device 1406 may, for example, include a dual chamber slot die coating device having a coating head 1408 with two orifices 1410 and 1412. A slurry delivery system may supply two different slurries to the coating head under pressure. Due to the revolving nature of backing roll 1404, material exiting the lower orifice or slot 1410 will contact substrate 1402 before material exiting the upper orifice or slot 1412. Accordingly, a first layer 1414 will be applied to the substrate and a second layer 1416 will be applied on top of the first layer.

Manufacturing method 500 may be performed using a dual-slot configuration, as depicted in FIG. 7, to simultaneously extrude the first layer and the second layer, or a multi-slot configuration with three or more dispensing orifices utilized to simultaneously extrude the first, second, and third layers. In some examples, such as when manufacturing method 500 is performed using the dual-slot configuration, the third layer may be coated onto the second layer by spraying, electrostatic coating, chemical or physical deposition, and/or the like. In some examples, the third layer may be applied after the first and second layers have dried, either with or without solvent. In some examples, the first layer may be applied to the foil substrate and dried, and the second layer and third layer may be simultaneously extruded onto the first layer.

In some examples, manufacturing method 500 may be performed using manufacturing system 1500, which includes a tri-slot configuration, such that the first layer, the second layer, and the third layer may all be extruded simultaneously, as depicted in FIG. 8. In manufacturing system 1500, a foil substrate 1502 is transported by a revolving backing roll 1504 past a stationary dispenser device 1506. Dispenser device 1506 may include any suitable dispenser configured to evenly coat one or more layers of slurry onto the substrate. In some examples, the substrate may be held stationary while the dispenser head moves. In some examples, both the substrate and the dispenser head may be in motion. Dispenser device 1506 may, for example, include a three chamber slot die coating device having a coating head 1508 with three orifices 1510, 1512, and 1514. A slurry delivery system may supply three different slurries to the coating head under pressure. Due to the revolving nature of backing roll 1504, material exiting the lower orifice or slot 1510 will contact substrate 1502 before material exiting the central orifice or slot 1512. Similarly, material exiting central orifice or slot 1512 will contact material exiting lower orifice or slot 1510 before material exiting upper orifice or slot 1514. Accordingly, a first layer 1516 will be applied to the substrate, a second layer 1518 will be applied on top of the first layer, and a third layer 1520 will be applied on top of the second layer.

In some examples, an active material layer, a hybrid layer, and a separator layer may all be extruded simultaneously. In another example, subsequent layers may be applied after initial layers have dried.

### G. Illustrative Combinations and Additional Examples

This section describes additional aspects and features of electrodes and electrochemical cells having gradated integrated separators, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. An electrode comprising:

a first layer layered onto and directly contacting a current collector substrate, the first layer comprising a first plurality of active material particles adhered together by a first binder;

a second layer layered onto and directly contacting the first layer, the second layer comprising a second plurality of active material particles mixed with a first plurality of electrically non-conductive inorganic separator particles and adhered together by a second binder; and

a third layer layered onto and directly contacting the second layer, the third layer comprising a second plurality of electrically non-conductive inorganic separator particles adhered together by a third binder.

A1. The electrode of paragraph A0, wherein the second and third layers collectively comprise a gradient of electrically non-conductive inorganic separator particles configured to provide ion conduction channels through the electrode.

A2. The electrode of paragraph A0 or A1, wherein the first layer and the second layer are electrically conductive, and wherein the third layer is electrically non-conductive.

A3. The electrode of paragraph A2, wherein the first layer and the second layer further comprise conductive additives.

A4. The electrode of any of paragraphs A0 through A3, wherein the first plurality of electrically non-conductive inorganic separator particles have sizes on the same order of magnitude as the second plurality of active material particles.

A5. The electrode of any of paragraphs A0 through A4, wherein the first plurality of electrically non-conductive inorganic separator particles are microporous, mesoporous, or macroporous, and are configured to provide ion conduction channels through the second layer.

A6. The electrode of any of paragraphs A0 through A4, wherein the first plurality of electrically non-conductive inorganic separator particles comprise agglomerations of smaller inorganic particles.

A7. The electrode of any of paragraphs A0 through A6, wherein the first plurality of electrically non-conductive inorganic separator particles comprise a ceramic material.

A8. The electrode of paragraph A7, wherein the first plurality of electrically non-conductive inorganic separator particles comprise alumina.

A9. The electrode of any of paragraphs A0 through A8, wherein the second plurality of electrically non-conductive inorganic separator particles comprise a ceramic material.

A10. The electrode of paragraph A9, wherein the second plurality of electrically non-conductive inorganic separator particles comprise alumina.

A11. The electrode of any of paragraphs A0 through A10, further comprising a first interlocking region disposed between and adhering the first layer and the second layer, wherein first fingers of the first layer interlock with second fingers of the second layer.

A12. The electrode of any of paragraphs A0 through A11, further comprising a second interlocking region disposed between and adhering the second layer and the third layer, wherein third fingers of the second layer interlock with fourth fingers of the third layer.

B0. An electrode comprising:

an active material layer layered onto and directly contacting a current collector substrate, the active material layer comprising a first plurality of active material particles adhered together by a first binder, wherein the active material layer is electrochemically active and electrically conductive;

a hybrid layer layered onto and directly contacting the active material layer, the hybrid layer comprising a second plurality of active material particles mixed with a first plurality of non-active ceramic particles and adhered together by a second binder, wherein the hybrid layer is electrochemically active and electrically conductive; and

a separator layer layered onto and directly contacting the hybrid layer, the separator layer comprising a second plurality of non-active ceramic particles adhered together by a third binder, wherein the separator layer is electrochemically inactive and electrically non-conductive; and

wherein the first plurality of non-active ceramic particles and the second plurality of non-active ceramic particles collectively provide ion conduction channels through the electrode.

B1. The electrode of paragraph B0, wherein the first plurality of non-active ceramic particles provide ion conduction channels between the separator layer and the active material layer.

B2. The electrode of paragraph B0 or B1, wherein the active material layer and the hybrid layer further comprise conductive additives.

B3. The electrode of any of paragraphs B0 through B2, wherein the first plurality of non-active ceramic particles have sizes on the same order of magnitude as the second plurality of active material particles.

B4. The electrode of any of paragraphs B0 through B3, wherein the first plurality of non-active ceramic particles are microporous, mesoporous, or macroporous, and are configured to provide ion conduction channels through the second layer.

B5. The electrode of any of paragraphs B0 through B3, wherein the first plurality of non-active ceramic particles comprise agglomerations of smaller ceramic particles.

B6. The electrode of any of paragraphs B0 through B5, wherein the first plurality of non-active ceramic particles comprise alumina.

B7. The electrode of any of paragraphs B0 through B6, wherein the second plurality of non-active ceramic particles comprise alumina.

B8. The electrode of any of paragraphs B0 through B7, further comprising a first interlocking region disposed between and adhering the active material layer and the hybrid layer, wherein first fingers of the active material layer interlock with second fingers of the hybrid layer.

B9. The electrode of any of paragraphs B0 through B8, further comprising a second interlocking region disposed between and adhering the hybrid layer and the separator layer, wherein third fingers of the hybrid layer interlock with fourth fingers of the separator layer.

B10. The electrode of any of paragraphs B0 through B9, wherein the first and second pluralities of non-active ceramic particles are electrically non-conductive.

C0. A method of manufacturing an electrode having a gradated separator, the method comprising:

coating an active material layer onto a current collector, the active material layer comprising a first plurality of active material particles;

coating a hybrid layer onto the active material layer, the hybrid layer comprising a second plurality of active material particles mixed with a first plurality of inorganic separator particles; and

coating a separator layer onto the hybrid layer, the separator comprising a second plurality of inorganic separator particles;

wherein the first plurality of inorganic separator particles are configured to provide ion conduction channels from the separator layer to the active material layer.

C1. The method of paragraph C0, further comprising forming a first interpenetrating boundary layer between the active material layer and the hybrid layer.

C2. The method of paragraph C1, wherein forming the first interpenetrating boundary layer between the active material layer and the hybrid layer includes simultaneously extruding the active material layer and the hybrid layer through respective orifices of a slot die.

C3. The method of paragraph C2, wherein coating the separator layer onto the hybrid layer comprises spraying the second plurality of inorganic separator particles onto the hybrid layer.

C4. The method of any of paragraphs C0 through C3, further comprising forming a second interpenetrating boundary layer between the hybrid layer and the separator layer.

C5. The method of paragraph C4, wherein forming a second interpenetrating boundary layer between the hybrid layer and the separator layer includes simultaneously extruding the hybrid layer and the separator layer through respective orifices of a slot die.

C6. The method of any of paragraphs C0 through C5, further comprising calendering the electrode.

C7. The method of any of paragraphs C0 through C6, wherein the first plurality of inorganic separator particles are microporous, mesoporous, or macroporous, and configured to provide ion conduction channels through the hybrid layer.

C8. The method of any of paragraphs C0 through C7, wherein the first plurality of inorganic separator particles have an average particle size on the same order of magnitude as the second plurality of active material particles.

C9. The method of any of paragraphs C0 through C8, wherein the first plurality of inorganic separator particles comprise a ceramic material.

C10. The method of paragraph C9, wherein the first plurality of inorganic separator particles comprise alumina.

C11. The method of any of paragraphs C0 through C10, wherein the second plurality of inorganic separator particles comprise a ceramic material.

C12. The method of paragraph C11, wherein the second plurality of inorganic separator particles comprise alumina.

### Advantages, Features, and Benefits

The different embodiments and examples of the electrodes and electrochemical cells having gradated integrated separators described herein provide several advantages over known separators for electrochemical cells. For example, illustrative embodiments and examples described herein improve ion conduction through a separator of an electrochemical cell.

Additionally, and among other benefits, illustrative embodiments and examples described herein provide electrochemically inactive ion conduction channels deep into the active material portion of an electrode.

Additionally, and among other benefits, illustrative embodiments and examples described herein increase compression resistance of an active material layer, providing a desirable density profile.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. An electrode comprising:
a first layer layered onto and directly contacting a current collector substrate, the first layer comprising a first plurality of active material particles adhered together by a first binder;
a second layer layered onto and directly contacting the first layer, the second layer comprising a second plurality of active material particles mixed with a first plurality of electrically non-conductive inorganic separator particles and adhered together by a second binder; and
a third layer layered onto and directly contacting the second layer, the third layer comprising a second plurality of electrically non-conductive inorganic separator particles adhered together by a third binder.

2. The electrode of claim 1, wherein the second and third layers collectively comprise a gradient of electrically non-conductive inorganic separator particles configured to provide ion conduction channels through the electrode.

3. The electrode of claim 1, wherein the first layer and the second layer are electrically conductive, and wherein the third layer is electrically non-conductive.

4. The electrode of claim 3, wherein the first layer and the second layer further comprise conductive additives.

5. The electrode of claim 1, wherein the first plurality of electrically non-conductive inorganic separator particles have sizes on the same order of magnitude as the second plurality of active material particles.

6. The electrode of claim 1, wherein the first plurality of electrically non-conductive inorganic separator particles are microporous, and are configured to provide ion conduction channels through the second layer.

7. The electrode of claim 1, further comprising a first interlocking region disposed between and adhering the first layer and the second layer, wherein first fingers of the first layer interlock with second fingers of the second layer.

8. The electrode of claim 1, further comprising a second interlocking region disposed between and adhering the second layer and the third layer, wherein third fingers of the second layer interlock with fourth fingers of the third layer.

9. An electrode comprising:
an active material layer layered onto and directly contacting a current collector substrate, the active material layer comprising a first plurality of active material particles adhered together by a first binder, wherein the active material layer is electrochemically active and electrically conductive;
a hybrid layer layered onto and directly contacting the active material layer, the hybrid layer comprising a second plurality of active material particles mixed with a first plurality of non-active ceramic particles and adhered together by a second binder, wherein the hybrid layer is electrochemically active and electrically conductive; and
a separator layer layered onto and directly contacting the hybrid layer, the separator layer comprising a second plurality of non-active ceramic particles adhered together by a third binder, wherein the separator layer is electrochemically inactive and electrically non-conductive; and
wherein the first plurality of non-active ceramic particles and the second plurality of non-active ceramic particles collectively provide ion conduction channels through the electrode.

10. The electrode of claim 9, wherein the first plurality of non-active ceramic particles provide ion conduction channels between the separator layer and the active material layer.

11. The electrode of claim 9, wherein the active material layer and the hybrid layer further comprise conductive additives.

12. The electrode of claim 9, wherein the first plurality of non-active ceramic particles have sizes on the same order of magnitude as the second plurality of active material particles.

13. The electrode of claim 9, wherein the first plurality of non-active ceramic particles are microporous, and are configured to provide ion conduction channels through the hybrid layer.

14. The electrode of claim 9, further comprising a first interlocking region disposed between and adhering the active material layer and the hybrid layer, wherein first fingers of the active material layer interlock with second fingers of the hybrid layer.

15. The electrode of claim 9, further comprising a second interlocking region disposed between and adhering the hybrid layer and the separator layer, wherein third fingers of the hybrid layer interlock with fourth fingers of the separator layer.

16. A method of manufacturing an electrode having a gradated separator, the method comprising:
coating an active material layer onto a current collector, the active material layer comprising a first plurality of active material particles;
coating a hybrid layer onto the active material layer, the hybrid layer comprising a second plurality of active material particles mixed with a first plurality of inorganic separator particles; and
coating a separator layer onto the hybrid layer, the separator layer comprising a second plurality of inorganic separator particles;
wherein the first plurality of inorganic separator particles are configured to provide ion conduction channels from the separator layer to the active material layer.

17. The method of claim 16, further comprising forming a first interpenetrating boundary layer between the active material layer and the hybrid layer.

18. The method of claim 16, further comprising forming a second interpenetrating boundary layer between the hybrid layer and the separator layer.

19. The method of claim 16, further comprising calendering the electrode.

20. The method of claim 16, wherein the first plurality of inorganic separator particles are microporous, and are configured to provide ion conduction channels through the hybrid layer.
